(19) United States
(12) Patent Application Publication
(10) Pub. No.: US 2007/0101424 A1
(43) Pub. Date: May 3, 2007

(54) Apparatus and Method for Improving Security of a Bus Based System Through Communication Architecture Enhancements

(75) Inventors: Srivaths Ravi, Plainsboro, NJ (US); Anand Raghunathan, Plainsboro, NJ (US); Srimat T. Chakradhar, Manalapan, NJ (US); Joel Coburn, Princeton, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/458,834

(22) Filed: Jul. 20, 2006

Related U.S. Application Data
(60) Provisional application No. 60/702,144, filed on Jul. 25, 2005.

(51) Int. Cl. H04L 9/00; G06F 12/14; G06F 11/00; H04L 9/32; G06F 17/00; G06F 11/30; H04K 1/00; G06F 12/16; G06F 15/18; G08B 23/00

(52) U.S. Cl. 726/22; 726/1; 726/23; 726/24; 726/25; 713/188

(57) ABSTRACT

A security policy associated with a system is evaluated. The system includes a communication bus having a data bus and a plurality of components interconnected via the communication bus. The system also includes a circuit configured to evaluate a security policy associated with the system by reading at least one data bus signal associated with a transaction between at least two of the plurality of components.

This application claims the benefit of U.S. Provisional Application No. 60/702,144 filed Jul. 25, 2005, which is incorporated herein by reference.

### BACKGROUND OF THE INVENTION

The present invention relates generally to electronic system security, and, in particular, to a security module embedded in a system to enhance the system's security.

Security threats, such as viruses, worms, and Trojan applications, often pose significant problems to the normal functionality of a system. For example, a security threat may cause a system to be inoperable or may render particular portions (e.g., programs) of the system to be inoperable. A security threat may also attempt to circumvent security policies (e.g., controlling privileges for usage of code, data, and/or services) of a system. This may occur through access control violations, information leakage and corruption, denial of service attacks, etc.

To prevent the security threats from affecting systems, systems typically execute anti-virus tools to detect the presence of threats or use software patches to resolve vulnerabilities. Although sometimes effective, these techniques are limited in scope to known viruses, worms, and vulnerabilities. Thus, to circumvent the known anti-virus tools or software patches, an individual can create a new virus or worm that will not be identified by existing anti-virus software or that exploits a new vulnerability.

As systems become more complex and networked, their vulnerability to security threats likely increases. An example is the emergence of new viruses and other means to target embedded devices such as mobile telephones, personal media players, satellite communication systems (e.g., in automobiles), etc.

Therefore, there is a need to better combat security threats rather than rely on existing security mechanisms.

### SUMMARY OF THE INVENTION

Rather than attempt to prevent security threats using software, the present invention addresses these threats through hardware enhancements to a system (i.e., the communication architecture of a system). As used herein, “system” refers to a system of hardware components interconnected within a chip, or on a board, through a bus-based communication architecture. Systems are typically designed by assembling various components (one or more processors, memories, application-specific hardware, peripherals, I/O controllers, etc.) on a single chip or board. The components are integrated using communication architectures (e.g., a bus, crossbar, or network on a chip). The purpose of a communication architecture is to facilitate communications between components in a system. In one embodiment, the communication architecture is a system bus having separate address and data lines (also referred to as an address bus and a data bus). In addition, the bus may also have control lines.

During system operation, a component may communicate with another component in the system in order to perform a required function. To achieve this communication, the system bus transmits signals between components. Signals are logical values that may be transmitted through various physical mechanisms, such as wires. The temporal sequence of these signals can be referred to as a transaction. Examples of a transaction include read, write, etc.

In accordance with an aspect of the present invention, a security policy associated with a system is evaluated and possibly enforced by a circuit (e.g., a security module) by reading data bus or address and data bus signals associated with a transaction. Further, information associated with a sequence of transactions, or statistics associated with a sequence of transactions, may be used by the circuit to determine whether a security policy is violated.

This circuit can include a data-based protection unit (DPU) for restricting data values written to a target component (e.g., data written to a memory location or to a specific register in a peripheral). The circuit can additionally include a sequence-based protection unit (SPU) for determining if a security policy is violated by checking a plurality of transactions executed. The circuit can additionally include a statistical transaction protection unit (TPU) for determining if the measured statistics of a sequence of transactions conflict with predetermined values associated with normal system behavior. The circuit can additionally include means for configuring the security module in a trusted manner for a given application.

These and other advantages of the invention will be apparent to those of ordinary skill in the art by reference to the following detailed description and the accompanying drawings.

### BRIEF DESCRIPTION OF THE DRAWINGS

FIG. 1(a) shows a block diagram of an example system-on-chip, with components connected using a system bus;

FIG. 1(b) shows a table of signals associated with an example system bus;

FIG. 2 shows a block diagram of a system-on-chip platform that performs multimedia content playback;

FIG. 3 is a flow chart of the steps performed by the system-on-chip platform to play the multimedia content;

FIG. 4(a) is a block diagram showing details of a stack overflow attack used to obtain a device key needed to play the multimedia content;

FIG. 4(b) shows a timing diagram of system bus signals associated with a processor reading from an illegal memory location;

FIG. 5(a) shows a block diagram of a compression/decompression interface memory map with a configuration of a digital rights management application;

FIG. 5(b) shows a software attack and a timing diagram associated with the software attack of a first central processing unit (CPU) writing an illegal value to a register;

FIG. 5(c) shows an embodiment of a plot of property value frequencies for 100,000 bus transactions during AES (Advanced Encryption Standard) decryption running on a simulation of the system-on-chip described in FIG. 1;

FIG. 5(d) shows an embodiment of signatures for the initial and normal phases of AES decryption and memory scan attack;

FIG. 5(e) shows an embodiment of a plot of the attack deviation from the initial signature along with the standard deviation of the initial signature;

FIG. 5(f) shows an embodiment of a plot of the attack deviation and the standard deviation for the normal signature;

FIG. 6 shows a block diagram of a security-enhanced communication architecture including a security evaluation module in accordance with an embodiment of the invention;

FIG. 7 shows a detailed block diagram of the security policy evaluation and enforcement module in accordance with an embodiment of the invention;

FIG. 8(a) shows a block diagram of a memory map and memory protection regions of a first and second CPU of a system in accordance with an embodiment of the invention;

FIG. 8(b) shows an address-based protection unit look-up table in accordance with an embodiment of the invention;

FIG. 9 shows a security enhanced interface for a compression/decompression (CODEC) interface in accordance with an embodiment of the invention;

FIGS. 10(a) and 10(b) show security automata that together enforce a digital rights management application's security policy to play content at most a predetermined number of times in accordance with an embodiment of the invention; and

FIG. 11 shows a block diagram of a transaction protection unit in accordance with an embodiment of the invention.

### DETAILED DESCRIPTION

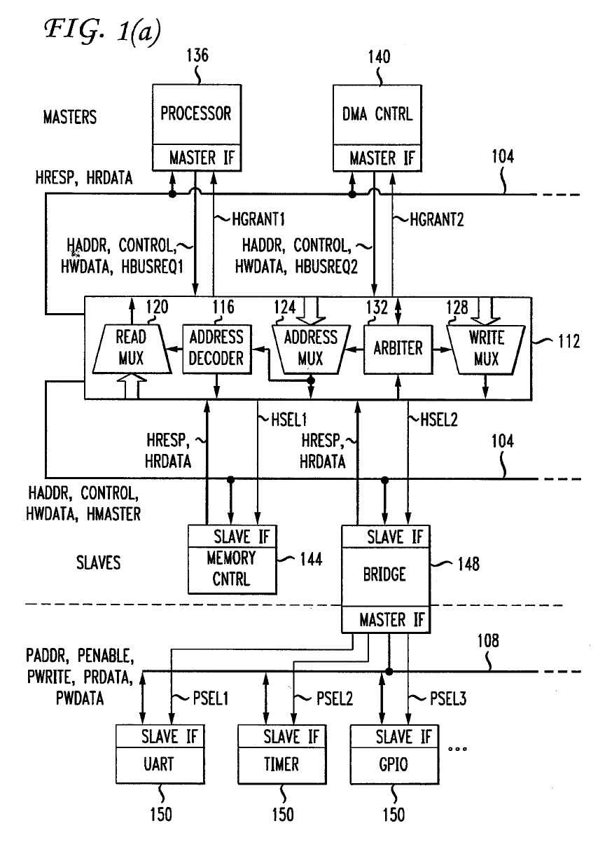

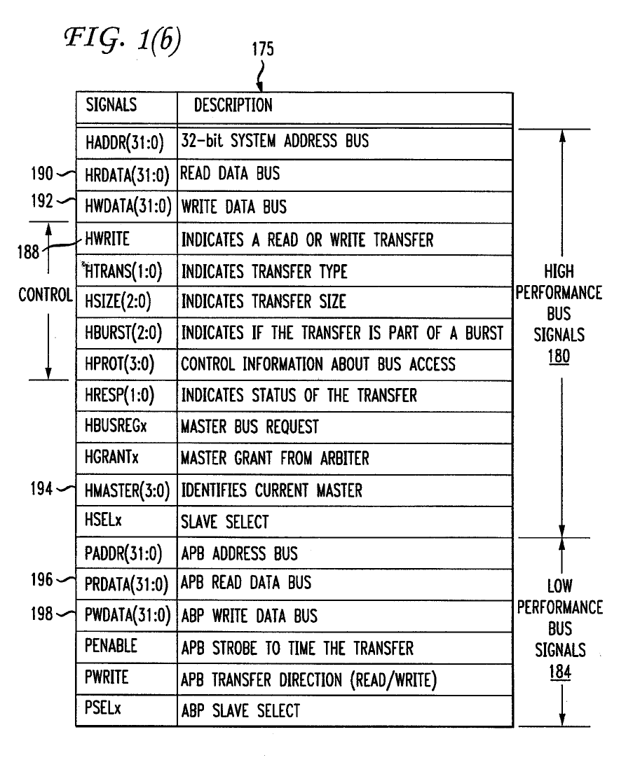

FIG. 1(a) is a block diagram of a prior art system 100 (such as an embedded system or a System-on-Chip (SoC)) that may be vulnerable to security threats. The system 100 shows an example system bus architecture (e.g., ARM's AMBA bus) which includes a high performance bus 104 for components (such as processors, memory, direct memory access (DMA) controllers, etc.) that use a high communication bandwidth. The system 100 also includes a peripheral bus 108 for lower bandwidth peripheral devices.

The high performance bus 104 includes interconnect wires for transmitting address, control, and data values. The high performance bus 104 also includes logic components 112 to implement a communication protocol associated with the high performance bus 104. The logic components 112 can include, for example, an address decoder 116, multiplexors (i.e., muxes) such as a read mux 120, an address mux 124, and a write mux 128, and an arbiter 132.

The arbiter 132 regulates bus traffic according to a configurable arbitration scheme. A bus transaction can be initiated when a component (e.g., a processor 136 or DMA controller 140) has requested access to the bus 104 and has been granted access by the arbiter 132.

The high performance bus 104 facilitates communication between master components, or components that initiate bus transfer requests, and slave components, or components that respond to bus transfer requests. The slave components are memory-mapped. As a result, communication transactions are encoded as reads and writes to specific memory addresses.

During normal system operation (e.g., a software application executing on the processor), multiplexers 124 and 128 route address, control, and write data from the appropriate master component (e.g., processor 136) to the slave component(s) (e.g., memory controller 144 or peripherals 150). The address decoder 116 notifies the desired slave component through a slave select signal. Another multiplexor 120 routes the slave response and read data to the master components.

The two buses 104, 108 communicate via a bridge 148. The bridge 148 acts as a slave on the high performance bus 104 and as a master on the low performance bus 108.

FIG. 1(b) shows a table 175 of the signals used during communications on the high and low performance buses 104, 108. A sequence of address, control, and data values are visible on the bus 104, 108, which reflect the communication transaction currently being performed in the system 100. Table 175 includes high performance bus signals 180 and low performance bus signals 184. High performance bus signals 180 include, for instance, an HWRITE signal 188 that indicates a read or write transfer, an HRDATA signal 190 which indicates a read data high performance bus, an HWDATA signal 192 which indicates a write data high performance bus, and an HMASTER signal 194 which identifies a current high performance bus master. Low performance bus signals 184 include a PRDATA signal 196 to indicate a read data low performance bus and a PWDATA signal 198 to indicate a write data low performance bus.

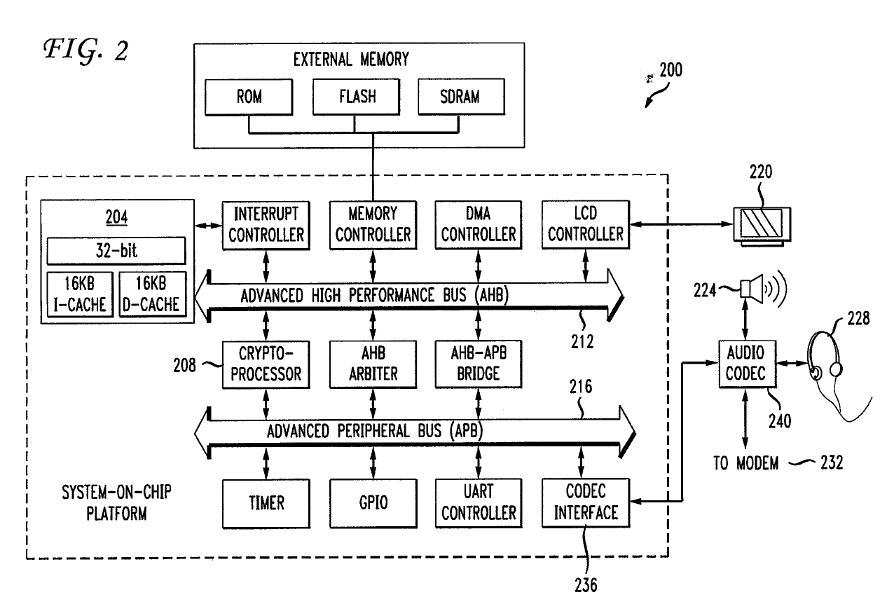

FIG. 2 shows a block diagram of a prior art system 200 that is vulnerable to a security threat. The system 200 performs audio/video (i.e., multimedia content) playback. An example of a security threat to system 200 is the unauthorized use of the multimedia content that the system 200 is designed to play back to a user. Unauthorized use of the multimedia content can include playing the content more than a predetermined number of times or playing content that has not yet been purchased. To protect the multimedia content from unauthorized use, content providers typically depend on technologies such as digital rights management (DRM) protocols.

The system 200 includes a first central processing unit (CPU) 204 and a second CPU 208. The first and second CPUs 204, 208 can perform a variety of functions. In one embodiment, the second CPU 208 offloads cryptographic computations from the first CPU 204. The system 200 also includes a high performance bus 212 and a low performance bus 216. The system 200 plays received multimedia content on a screen 220, speaker 224, and/or headphones 228. The system 200 may also transmit the received multimedia content to a modem 232 for playing on a remote computer.

The system 200 also includes peripheral devices such as a compression/decompression (CODEC) interface 236 that communicate over the low performance bus 216. The CODEC interface 236 provides the interface for communications between the modem 232 and audio components (e.g., speaker 224 or headphones 228) and the rest of the system 200.

The following is an example of audio content being delivered to the system 200 for playback. The audio content is received by the system 200 in encrypted form along with an encrypted rights object. The rights object contains cryptographic keys for unlocking the content, message authentication codes to ensure that the content has not been tampered with, and permissions and constraints for the content's use on the system 200. The rights object is encrypted with a key that is device-specific (i.e., associated with the specific system that requested the content (i.e., system 200)).

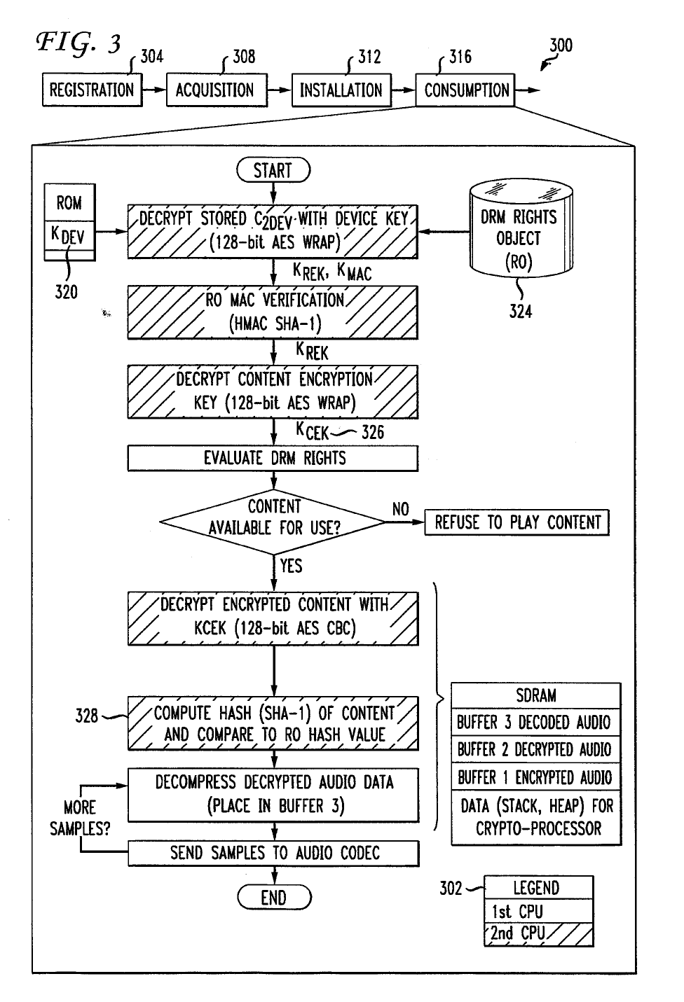

FIG. 3 illustrates a flowchart 300 showing the steps performed by the system 200 to play the received audio content. Although described below with respect to the playback of audio content, it should be noted that the example also applies to the playback of any multimedia content such as video content. Further, although media playback is used as an example, the description applies to any system vulnerable to one or more security threats. The steps performed by the first CPU are shown as unshaded blocks while the steps performed by the second CPU are shown as shaded blocks (see legend 302).

The main steps include registration 304, acquisition 308, installation 312, and consumption 316. The registration step 304 is when the system 200 registers with a rights issuer to obtain a digital rights security policy associated with the protected content (i.e., media). The acquisition step 308 is when the digital rights security policy is acquired. The installation step 312 is when the digital rights policy object is installed on the embedded system for playback. In the consumption step 316, the embedded system plays the media in accordance with the digital rights management policy.

For the lifetime of a particular piece of protected content on the system 200, the registration step 304, the acquisition step 308, and the installation step 312 traditionally occur once. Upon the completion of these steps 304-312, the system 200 has registered with a rights issuer, requested and received a protected rights object, verified the integrity and authenticity of the rights object, and unwrapped the security keys contained in it.

In one embodiment, the tasks performed to play back the audio content are partitioned between the two CPUs 204, 208. In particular, in FIG. 3, the shaded blocks indicate the decryption and hash operations in the consumption step that are performed by the second CPU 208. The first CPU 204 interprets he rights object to determine if the audio content is valid for use. As shown, the first CPU 204 needs the device key (K_{DEV}) 320 stored in memory (e.g., Read-Only Memory, or ROM) to interpret the DRM rights object 324. Using the device key 320, the first CPU 204 decrypts the content encryption key 326 from the rights object 324.

If the contents are valid for use, the encrypted content is decrypted by the second CPU 208 using the content encryption key 326. The message digest or hash of the decrypted content is then computed and compared against a reference value included with the rights object 324. The audio data is now ready for decompression and playback.

An example of a security attack on the system 200 is the use of a stack overflow attack to retrieve the device key 320. After obtaining the device key 320, a user can circumvent the rights object 324 to obtain unlimited use of the protected content, including the ability to distribute the content in plain form (i.e., unencrypted).

Specifically, an attacker causes a buffer of a system software function's stack frame of a software application to overflow. The attacker also causes the function's return address to point to malicious code. The function targeted for the attack is executed after the rights object 324 has been evaluated, when the application prints out user-supplied song information to the screen.

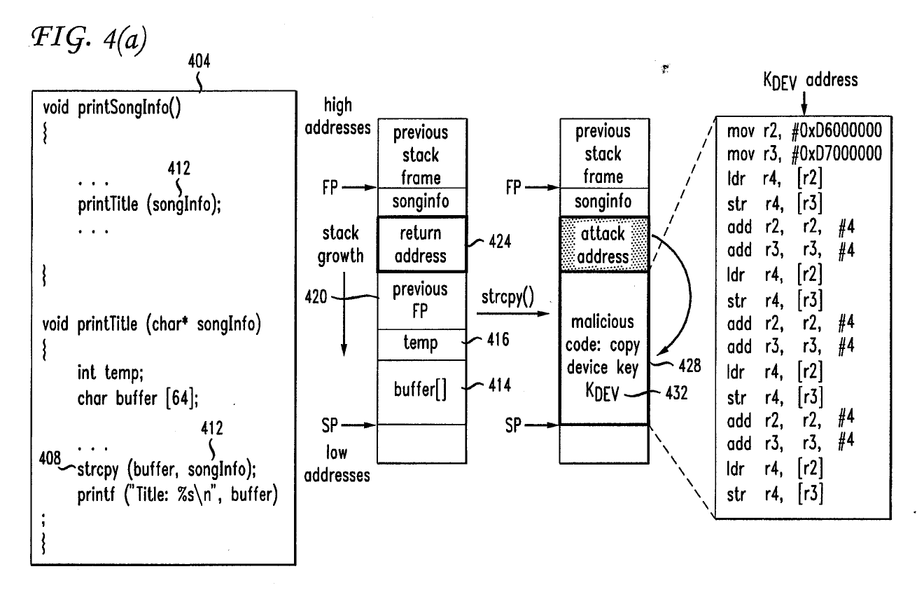

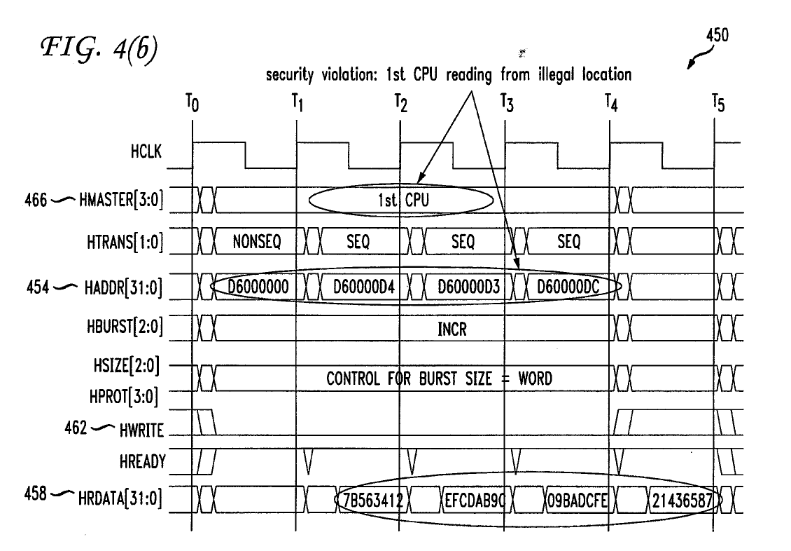

FIG. 4(a) shows details about the stack overflow attack that targets the device key 320. The function printTitle( ) shown in printTitle code 404 uses the library function strcpy( ) 408 to extract the song title from the input string songlnfo 412. The function strcpy( ) does not perform bounds checking, so if the title exceeds the size of a memory buffer 414 used to store the title, then strcpy( ) overwrites the local variable temp 416, the previous function frame pointer (FP) 420, and the function return address 424. The input string is maliciously crafted to contain attack code and a corrupted return address that points to the initial instruction of the attack code. The malicious code 428 then copies the device key 432.

The system 200 reveals information about the security violation. FIG. 4(b) shows a timing diagram 450 of the first CPU 204 during the “illegal” obtaining of the device key 432. Access to the device key 432 is recognizable because the key 432 has a unique address that appears on bus signal HADDR 454. The key data at the key address is shown on the read data signal HRDATA 458. Because the HWRITE signal 462 goes low, these transactions are read transactions. Also, the HMASTER signal 466 shows that the first CPU is initiating the read. This is inconsistent with FIG. 3 which shows the requirement that only the second CPU 208 needs to read the device key 432. Because the observed bus transactions were initiated by the first CPU 204, a security violation has occurred. Although the above example uses a stack overflow attack, the analysis applies to any other attack such as a heap overflow, format string attack, etc.

Peripheral vulnerabilities can also be used to launch attacks. For example, the IEEE 1394 interface allows client devices to access system memory directly, which can be used to launch various attacks including kernel memory tamper, peripheral data corruption, etc.

Referring again to FIG. 2, the CODEC interface 236 is a slave on the low performance bus 216 that communicates with off-chip CODECs (e.g., audio CODEC 240) through a particular protocol. In one embodiment, there are four separate channels to support modem, audio, headset, and microphone devices. Suppose channel 1 contains audio data for the speaker, channel 2 carries modem data, channel 3 contains headset data, etc. The configuration of the CODEC interface depends on the requirements of the current application. For example, if the DRM rights object prohibits the distribution of content, the data cannot be transmitted to any device other than an audio output device (headset or speaker). Therefore, the audio player is limited to using only channels 1 or 3 to play audio. Any attempt to use other channels can lead to forwarding of content to other medias/users, completely bypassing the protection of the DRM protocol.

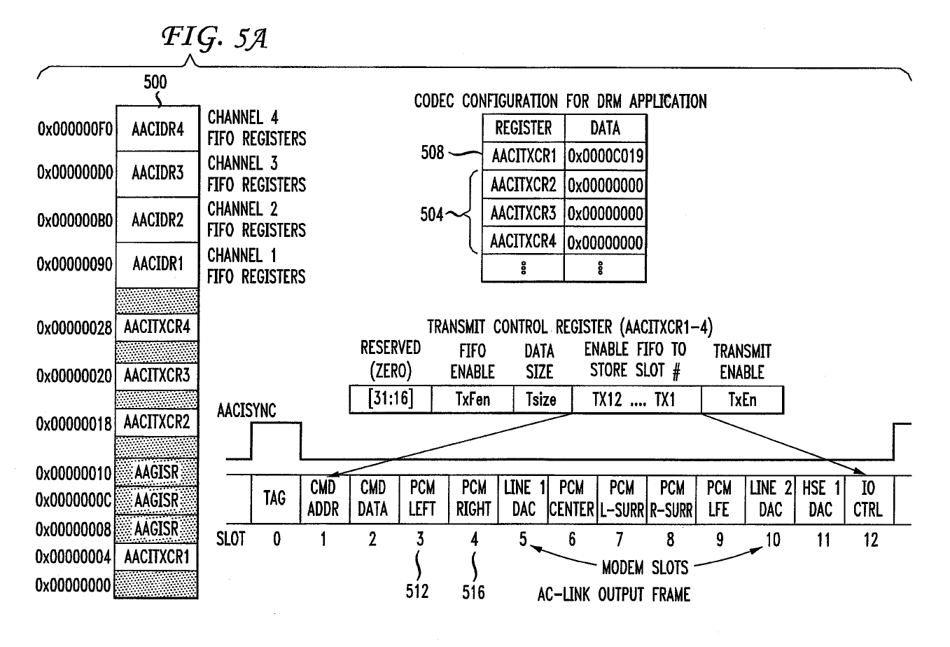

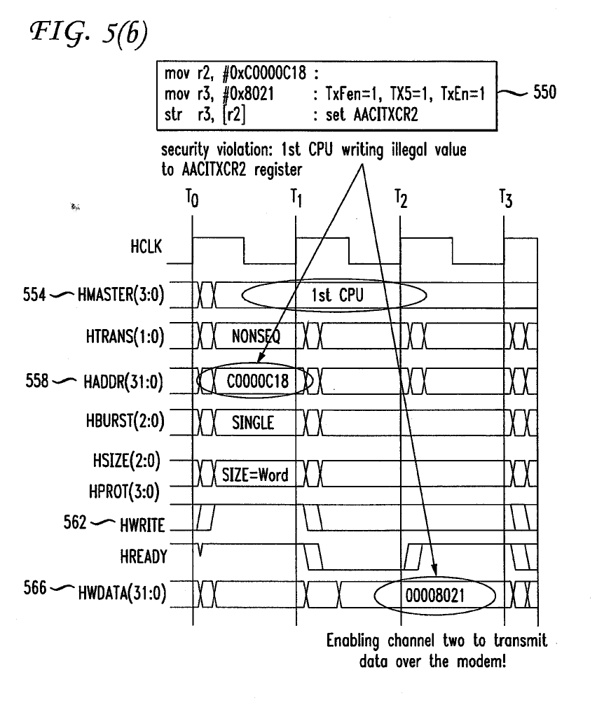

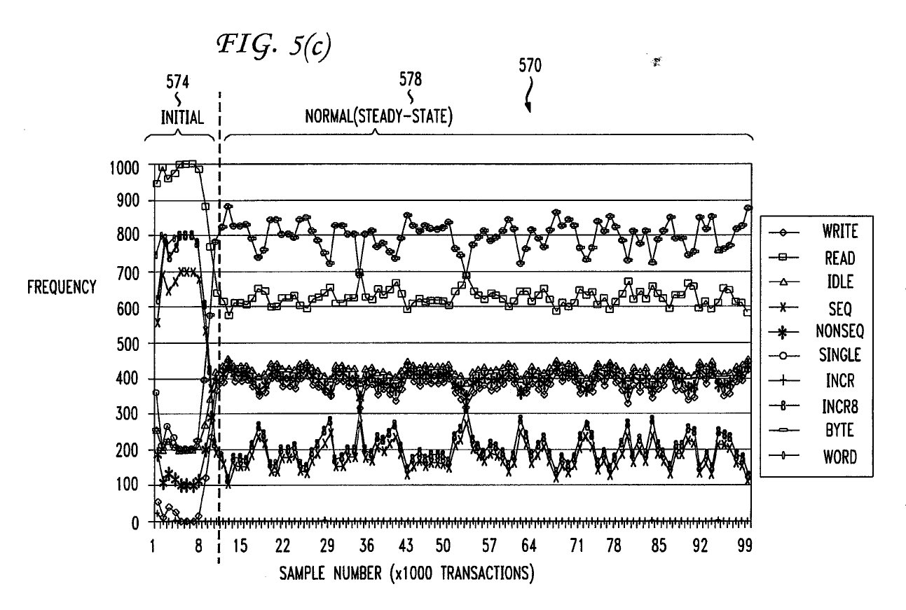

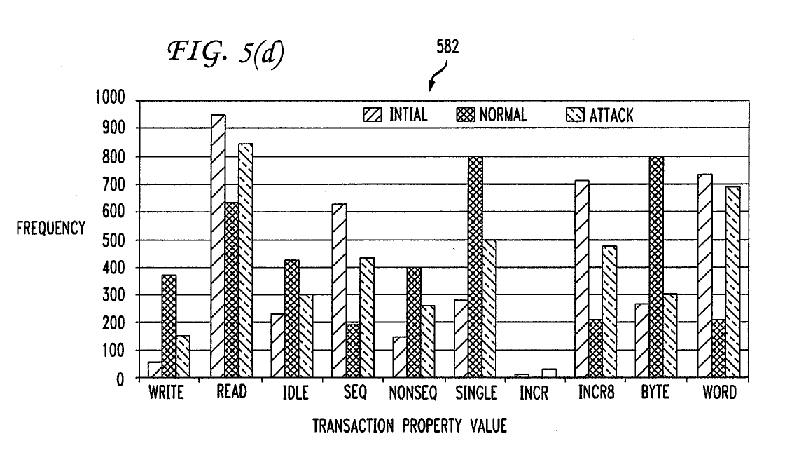

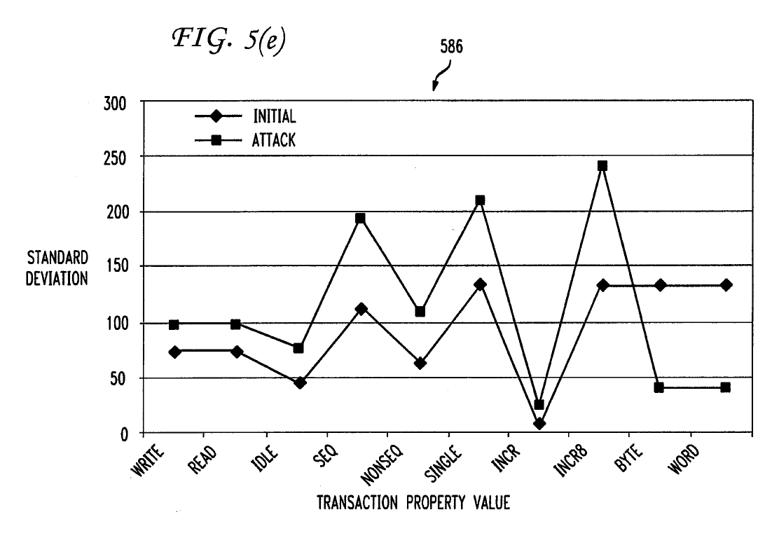

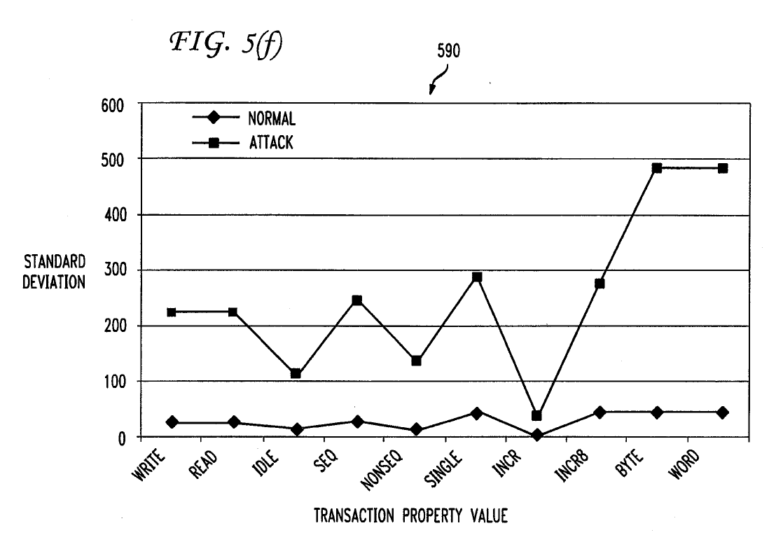

FIG. 5(a) shows the memory map 500 for the CODEC interface's control and data registers, along with a DRM-compliant configuration. The memory map 500 shows the addresses corresponding to various control and data registers. Table 502 lists the values present in the transmit control registers of channels 1, 2, 3, and 4. For this example, based on the restricted usage model of the DRM application, the transmit control registers 504 of channels 2, 3, and 4 (AACITXCR2-4) are set to zero, while AACITXCR1 508 is set to a value of 0x0000C019. This setting enables parameters 512, 516 (i.e., TX3 and TX4) to equal 1 in AACITXCR1 that allows for the usage of the audio CODEC for PCM left and PCM right audio data output only. The DRM application sets this configuration prior to playing protected content. However, any application vulnerability, such as buffer overflow, can be exploited to re-configure the CODEC interface and circumvent the protection mechanism.

FIG. 5(b) shows attack code 550 that configures the CODEC interface to transmit modem data through channel 2. The bus signals during this transaction can be checked to detect this protocol violation. The HMASTER signal 554 indicates that the first CPU has initiated the data transfer. The address of AACITXCR2, the transmit control register for channel 2, appears on HADDR 558. The HWRITE signal 562 goes high indicating that the transaction is a write. One cycle later, the configuration data is visible on HWDATA 566, where it is apparent that a “non-zero” value (0x00008021) is written to AACITXCR2 (a setting of TxFen=1, TxEn=1, and TX=5), resulting in forwarding of unencrypted audio samples from the device to the modem.

Thus, the security violation of the first CPU writing an illegal value to a register (e.g., the AACITXCR2 register) can also be detected from the communication signals (e.g., HWDATA 566) transmitted over the bus. In particular, these attacks can often be detected by monitoring a combination of bus signals—address, control, and data, and enforcing appropriate policies that regulate peripheral configuration and usage.

Many software attacks scan memory to expose sensitive data. A typical objective of a memory scan attack is to locate a cryptographic key. Since cryptographic keys tend to be randomly chosen, they can often be found among other data by locating areas with high entropy.

In the context of a DRM application, and specifically during decryption of protected content, a memory scan attack typically sequentially copies each word of application data to a free memory region that can later be transmitted over a network or saved to disk. To transfer control to the malicious code, a stack overflow attack is often utilized. In this instance, the stack is overwritten when a corrupted decryption key of an illegal length is copied from memory to a local buffer.

The means used to launch an attack may not always be detectable from the communication architecture (e.g., bus). This is evident by the fact that the communication architecture typically has no specific knowledge of program state, such as the contents or structure of the stack and heap. Instead, bus transaction information often reveals an attack as a deviation from normal (i.e., predetermined) application behavior observed over a period of time. While a trace of bus transactions often provides an accurate account of application activity from a system perspective, it is typically impractical to store and manipulate this (often large) amount of data.

Bus transaction properties (e.g., read/write, transfer type, transfer size, burst type, etc.) can be aggregated to generate a statistical signature for an application. An application signature is a collection of property value frequencies that are averaged from each sampling period during execution of the application. In one embodiment, the occurrence of property values such as IDLE, BUSY, SEQUENTIAL, or NONSEQUENTIAL are counted over a sampling period. These property values can be identified by the transfer type signal HTRANS[1:0]. These measurements are analogous to the count taken for each bin in a histogram.

FIG. 5(c) shows an embodiment of a plot 570 of the property value frequencies for 100,000 bus transactions during AES (Advanced Encryption Standard) decryption running on a simulation of the SoC platform described in FIG. 1. The sampling period is 1,000 bus transactions, and property values with a non-zero frequency are illustrated in the plot 570. The values Read and Write are based on the HWRITE signal. SINGLE, INCR, and INCR8 represent values seen for the HBURST[2:0] signal, and BYTE and WORD represent HSIZE[2:0] values. In one embodiment, after an initial 10,000 transactions (the first 10 samples), the application has warmed up its caches and reached an approximate steady-state. The AES algorithm typically exhibits fairly regular behavior, but the effects of caching often cause some variation over time. Despite these irregularities, the statistical nature of this method of observation makes the application signature distinguishable from a memory scan attack.

In one embodiment, there are two phases of application execution: an initial phase 574 and a normal (steady-state) phase 578. Because the signature of these two phases 574, 578 differs, both signatures act as a reference for detecting abnormal application behavior.

FIG. 5(d) displays an embodiment of signatures 582 for the initial and normal phases of AES decryption and the memory scan attack. The property value frequencies of the attack are often distinguishable from the AES application signatures.

In one embodiment, the attack deviation (the difference between the current sample data and the application signature) is compared with the standard deviation of the signature to detect an abnormality. In particular, the abnormality is detected by comparing new observations against fixed limits. In one embodiment, the limits are defined by the means and standard deviations measured from a pre-generated application profile.

FIG. 5(e) shows an embodiment of a plot 586 of the attack deviation from the initial signature along with the standard deviation of the initial signature. FIG. 5(f) similarly shows a plot 590 of the attack deviation and the standard deviation for the normal signature. Due to a steady-state behavior, the standard deviation of the normal signature is low, so the attack is outside the acceptable range of property value frequencies. The initial signature, however, has a much larger standard deviation that closely follows and even intersects the attack deviation. In one embodiment, the intersected property value, the number of WORD transactions, is discarded because it is masked by the initial signature.

The communication architecture may therefore be augmented to monitor transaction property values and produce statistics that identify an application's behavior. Using application signatures, the communication architecture can detect anomalies in a system that are characteristic of a security attack. Although the description above described an example of how a memory scan attack is detected, this method can extend to any attack that manifests itself in a sufficiently large number of bus transactions.

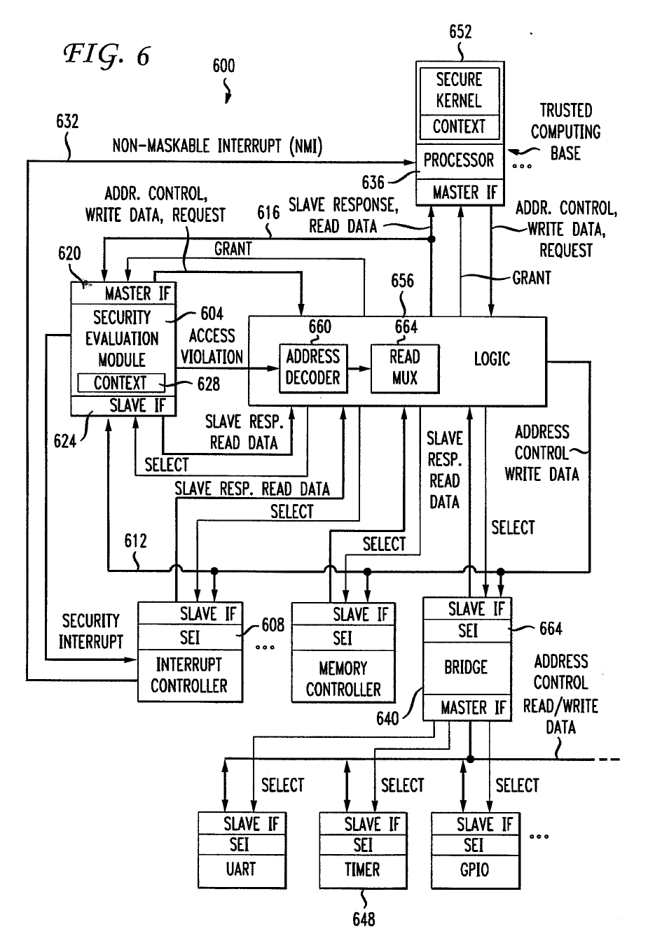

FIG. 6 is a block diagram of a security-enhanced communication architecture (SECA) 600 in accordance with the present invention for addressing the security issues described above. The enhancements can be realized as a single centralized module or as a distribution of modules across the topology of the communication architecture.

In one embodiment, the SECA configuration 600 includes a Security Evaluation Module (SEM) 604 and a Security Evaluation Interface (SEI) (e.g., SEI 608) for each slave device. The SEM 604 is a plug-in hardware block responsible for monitoring system communication and evaluating (e.g., enforcing) one or more programmed security policies.

The SEM 604 acts as both a master component and a slave component on the high performance bus of the SECA 600. The high performance bus includes several communication lines, such as lines 612 and 616. The evaluation of one or more security policies can include reviewing signals read from the communication bus (e.g., the high performance bus), notifying another component (e.g., another processor) when there is a security policy violation, and/or enforcing the security policy by blocking a bus transaction.

The SEM 604 includes a master interface (IF) 620 for communicating as a master component and a slave IF 624 for communicating as a slave component. Through its master interface 620, the SEM 604 can configure the slave SEIs and generate security status messages when violations are detected. Through its slave interface 624, the SEM 604 is programmed with security configurations for multiple contexts. The context of a component is reflective of the state of the component for which specific security privileges apply (for example, the context may correspond to the identifier or ID associated with an application or process executing on the processor). The context can range from coarse-grained distinctions, such as trusted or untrusted, to fine-grained distinctions, such as with an application identifier.

The SEM 604 includes a Context register 628 that determines which security configuration is evaluated (e.g., enforced). In one embodiment, the Context register 628 is an identifier of the application being executed. When a security violation occurs, the SEM 604 can generate an interrupt that appears on the non-maskable interrupt (NMI) line 632 of processor 636.

Like the bridge 148 in system 100, the SECA 600 also includes a bridge 640. The bridge 640 acts as a master and a slave and includes SEI 644. The bridge SEI 644 filters the values that can reach the data and control registers of a peripheral device (e.g., timer 648) in order to keep the peripheral device (e.g., timer 648) in a known valid state. The valid states for a peripheral device depend on the access level of the current execution context. The SEM 604 maps a context to an access level for each peripheral device. When a context switch occurs, the SEM 604 writes the corresponding access level to a configuration register in the SEI of each peripheral device. Depending on the complexity of the slaves, some security policies may be incorporated into the bridge 640.

Another security enhancement of the SECA 600 is a secure kernel 652 executing on the processor 636. The secure kernel 652 results in the processor 636 being a trusted computing base (TCB). A TCB-enhanced processor provides a higher level of security assurance during boot and run time, and can facilitate the secure configuration and functioning of the security evaluation module in SECA 600.

SECA 600 operates in one of three modes—program mode, monitor mode, and response mode. Program mode involves transferring security configuration data from the processor 636 (i.e., the TCB) to the SEM 604. The SEM 604 in turn configures the SEIs. In monitor mode, the SEM 604 samples each bus transaction and checks for security violations according to the programmed security policies and the current Context register value. When a security violation occurs, the SEM 604 notifies the processor with a NMI. The NMI is vectored to a response interrupt service routine (ISR) within the secure kernel 652. The security status data is written to a buffer in memory that will be read by the response ISR.

In another embodiment, a protected ISR is not used to respond to security violations. Instead, components of the high performance bus logic 656 are enhanced to block bus transfers when an illegal access is attempted. In particular, the address decoder 660 and the read mux 664 may be modified to block bus transfers when an illegal access is attempted.

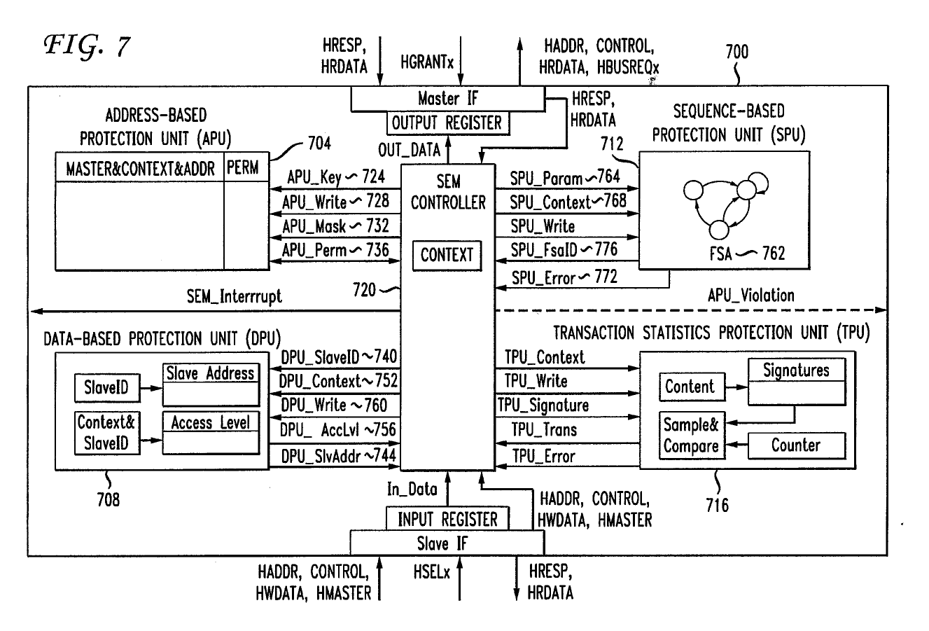

FIG. 7 is a detailed block diagram of an SEM 700 responsible for monitoring communications in a system. The SEM 700 includes three security modules—an Address-based Protection Unit (APU) 704, a Data-based Protection Unit (DPU) 708, and a Sequence-based Protection Unit (SPU) 712. The SEM 700 also includes transaction statistics protection unit (TPU) 716 to monitor the occurrence of bus transaction property values to determine if the behavior of the executing context approximates normal application behavior.

The APU 704 enforces access control rules (read-only, write-only, read-write, and not accessible) that specify how a component can access a device while in a particular context. The APU 704 uses a look-up table where each entry contains permissions for a region in the address space. In one embodiment, a two-bit (i.e., a read bit and a write bit) encoding scheme is used for the permissions: 00 is not accessible, 01 is read-only, 10 is write-only, and 11 is read-write. Each entry in the table is indexed by the input signal APU_Key 724. In one embodiment, the APU_Key signal 724 is the concatenation of the high performance bus signal HMASTER, the Context register, and the HADDR signal. An entry in the look-up table can be programmed via one or more of the signals communicated between the SEM controller 720 and the APU 704. For example, an entry can be programmed through the APU_Key signal 724, APU_Mask signal 732, and APU_Perm signal 736 when the APU_Write signal 728 is high.

In one embodiment, the look-up table does not contain entries for the entire address space. Instead, the look-up table contains entries for regions that are accessible (e.g., readable, writeable, or both). Thus, any APU_Key signal 724 that cannot be found in the table indicates that the address is not accessible (00 permission value) by the requesting bus master. The APU signal APU_Perm 736 returns the permissions for the attempted access to the SEM controller 720 when the APU_Write signal 728 is low.

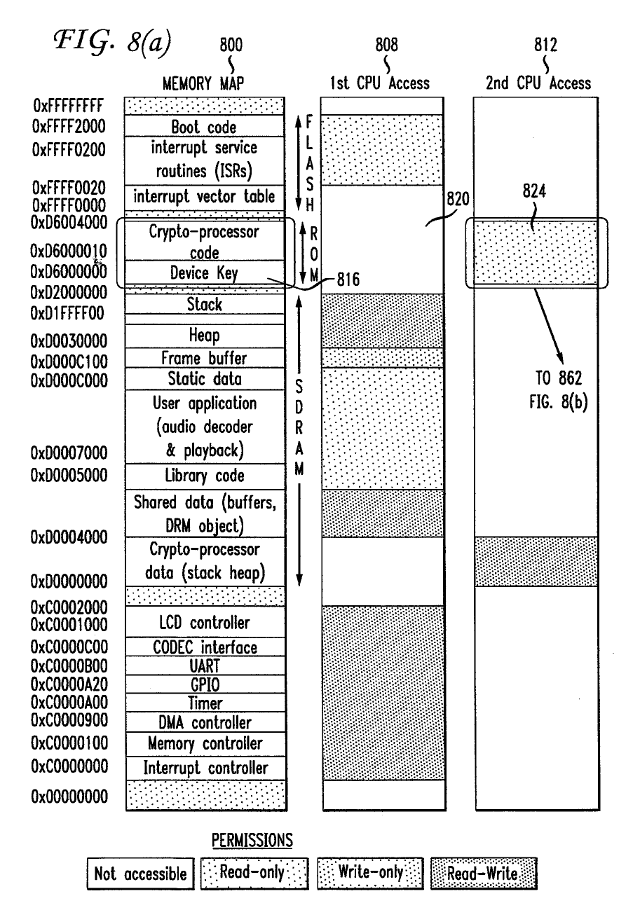

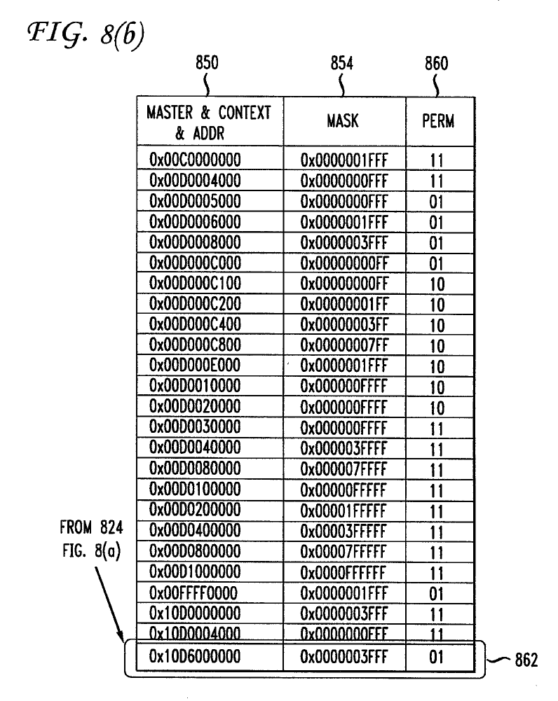

FIG. 8(a) shows a memory map 800 and memory protection regions for memory associated with the digital rights management (DRM) rights object described above (with respect to FIGS. 2 and 3). The protection regions for the first CPU 808 and the second CPU 812 isolate the data and code sections of the processors from one another. The device key (K_{DEV}) 816 stored in ROM and as described above is now protected because the first CPU 808 does not have permission to access the key data stored at address 0xD6000000 (shown as white area 820) and the second CPU 812 has read-only access to this location (shown as shaded area 824).

FIG. 8(b) shows APU look-up table entries for “safe” execution of the DRM object. Each entry defines a region of memory, which is determined by a search key 850 (first column), a mask value 854 (second column), and a permission 860 (third column). In one embodiment, the search key 850 includes four bits for the master component, four bits for the Context register, and 32 bits for the memory address. The first CPU is master 0 and the second CPU is master 1. The kernel (i.e., the TCB) has assigned Context=0 for the DRM rights object. The mask value 854 specifies the bits of the search key 850 that are “don't cares”. As described above, the permission 860 indicates what type of permission (e.g., read, write, read-write, or no access) the CPU has for the memory address(es).

The last entry 862 of the table has the search key equal to 0x10D6000000, the mask equal to 0x0000003FFF, and permission 860 equal to 01. The start address for the memory region is 0xD6000000. A bitwise OR of the start address and the mask gives an end address of 0xD6003FFF. In this address range, the second CPU has read-only access while the first CPU is not allowed access to this region of memory because there is no corresponding entry in the table.

In one embodiment, the look-up table is implemented as a ternary content addressable memory (TCAM). The look-up table is essentially a fully-associated cache of memory protection regions. The number of entries per application and bus master component is not fixed. Each entry may contain a valid bit indicating whether or not the entry is currently being used by an application. When an application terminates or is killed, the SEM controller 720 invalidates the application's protection region entries. During the programming phase, each new memory region is written to a vacant (invalid) TCAM entry and the corresponding permission value is written to Random Access Memory (RAM). In one embodiment, the APU registers are programmed during boot time of the SEM 700.

Referring to FIG. 7 again, the DPU 708 ensures a secure operating state for a given application. The DPU 708 specifically regulates the data values written to memory and other devices accessible through the address space. For the current Context register, the DPU 708 stores configuration data for peripheral devices to specify the allowable operating modes. For example, in the case of a DRM application, the CODEC interface is permitted to use channel 1 for audio output. During a bus transfer, the DPU 708 determines whether the HWRITE signal is high and that HADDR signal corresponds to a peripheral register. If so, then the HWDATA value is compared against the stored configuration data for the register. A security violation occurs for any undefined write data that puts the peripheral in an untrusted state. In one embodiment, the DPU 708 does not check the HMASTER signal because only one bus master component typically configures a slave device in a given Context.

The DPU 708 is responsible for configuring the SEI at each peripheral for data-based protection. In particular, in the DPU 708, there is a memory to store the address of each peripheral's configuration register. The DPU_SlaveID input signal 740 is used to look up the configuration register address, which appears on the DPU_SlvAddr lines 744. There is another memory (or memory region) to store access level values. An access level represents a set of valid operations for the device in the context of the current application. The number of access level bits is scalable. In one embodiment, there are four access level bits, providing 16 potential operating modes for a peripheral device. The DPU_SlaveID input signal 740 and the DPU_Context signal 752 are concatenated to index the access level which is sent to the SEM controller 720 through the DPU_AccLvl signal 756. The SEM controller 720 initiates a bus transaction to write DPU_AccLvl 756 to the register at DPU_SlvAddr 744. The DPU 708 can be programmed by setting the DPU_Write signal 760 high and providing values on the DPU_SlvAddr lines 744 and DPU_AccLvl lines 756.

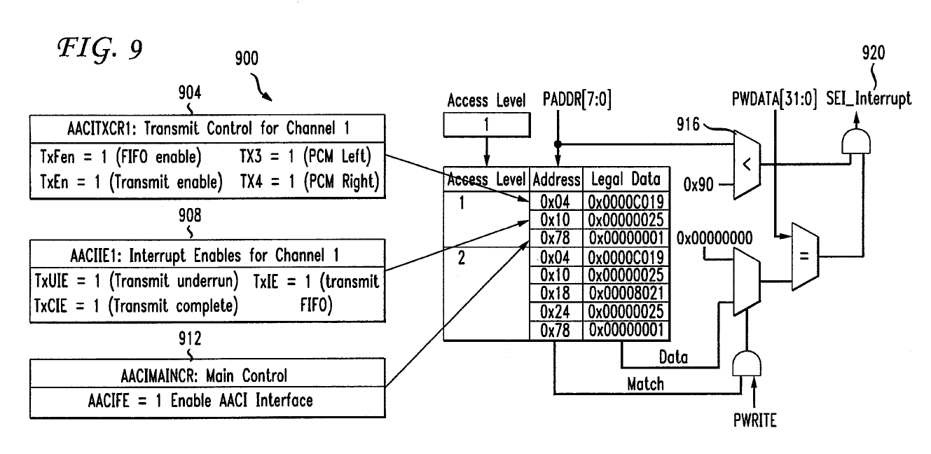

The SEI that accompanies each slave device is responsible for enforcing data-based protection. FIG. 9 shows the SEI 900 for the CODEC interface. A look-up table holds the valid peripheral configuration data that is indexed by the access level and register address. In one embodiment, three access levels are present in the security model represented in FIG. 9:
Level 0: Access level 0 is implicit and does not need a look-up table entry. If an application operates at this level, it may only write zero values to the control registers. Thus, the peripheral is essentially frozen and cannot be put in an operational mode. All applications that do not access the CODEC are configured with level 0 access.
Level 1: The CODEC interface is configured for the DRM application in which one channel is used for audio output. This access level can also be used for any other application that involves audio playback. FIG. 9 shows three registers 904, 908, 912 that have to be set correctly to permit use of the CODEC interface. The transmit control register AACITXCR1 904 is configured to enable AC-link output frames, enable the data FIFO, and map the data to the PCM left and PCM right slots of the output frame. Transmit interrupts for channel 1 are enabled in the AACIIE1 register 908. The interface enable bit of the main control register AACIMAINCR 912 is raised high to turn the CODEC interface on.
Level 2: This level is available for applications that need to be able to output both audio and modem data from the CODEC interface. Besides the control registers that configure channel one for audio output, the transmit control register AACITXCR2 (address 0x18) and the interrupt enable register AACIIE2 (address 0x24) for channel two have to be set correctly.

A control register that is not defined in the look-up table is inoperable from the current access level. The SEI 900 also includes an address comparator 916 to determine if the intended access is to a control register or to a data register. The channel data FIFOs occupy the addresses above 0x90, so the SEI_Interrupt 920 is activated when the address is below this threshold.

Referring again to FIG. 7, the SPU 712 (and sequence-based protection) relies on the fact that a sequence of bus transactions can be used to define a signature of expected behavior or an attack. This signature can be implemented as a finite-state automata (FSA) 762, also referred to below as security automata.

The SPU 712 can be used to implement various application-specific security policies based on the execution context. In one embodiment, the security automata parameters are configurable at run-time, but the'security automata 762 themselves are fixed during the design phase. The input SPU_Param 764 is used to initialize the FSAs 762 based on the current SPU_Context 768. When an error is detected by an FSA 762, the SPU 712 raises the SPU_Error flag 772 and returns the identification of the FSA 762 through the SPU_FsaID output signal 776.

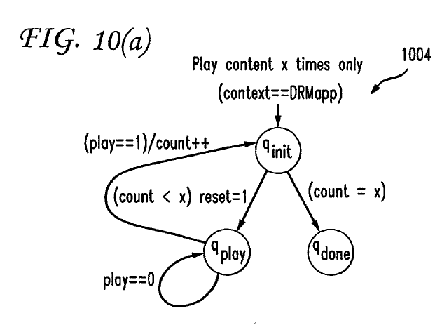

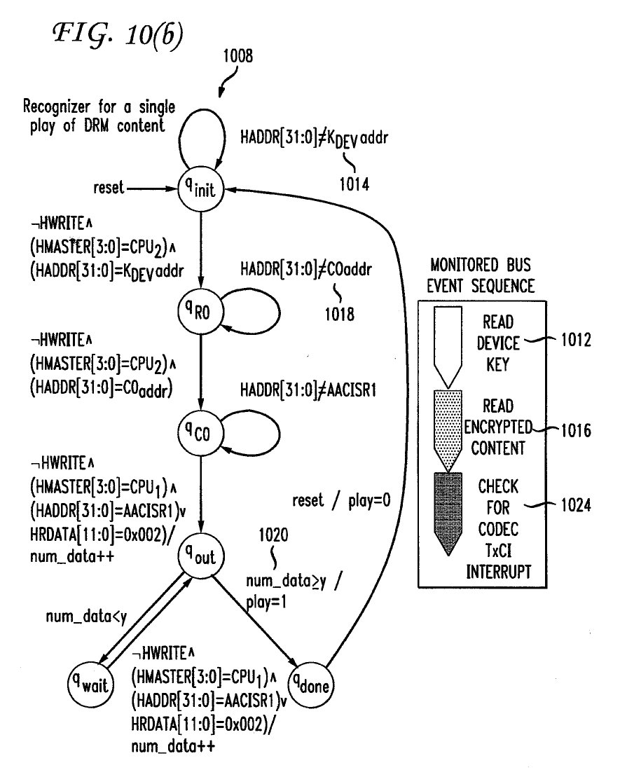

FIGS. 10(a) and 10(b) show two security automata that together enforce the DRM application's security policy of “play content at most x times”. The first automaton 1004 (shown in FIG. 10(a)) monitors and enforces the policy that the content is played up to x times. The second automaton 1008 recognizes when content has been played once and signals the first automaton 1004 (flag play). The maximum number of allowed plays x is given by the DRM rights object. Through a non-volatile, memory-mapped register, the application reads back the number of plays used count to determine if a play request is valid. If the application attempts to playback content when count is equal to x, then a policy violation is detected and the processor is notified.

The second automaton 1008 generates the play input for the first automaton 1004 if the correct sequence of bus events occur. The first step of the sequence is for the second CPU to read the device key in step 1012, indicated to the second automaton 1008 by the parameter K_{DEV}addr 1014. Next, the second automaton 1008 waits in the q_{RO} state to signify that the rights object is being processed. When the second CPU reads the first address of the encrypted content (e.g., audio), the second automaton 1008 enters state q_{CO} to show that the content is being read in step 1016. The second automaton 1008 compares the address seen on the bus with the address associated with the encrypted content (parameter COaddr 1018). The second automaton 1008 then counts the number of audio samples (num_data) 1020 output to the CODEC and compares the number with a parameter y, which equals a threshold specified in the DRM rights object.

When the first CPU reads the interrupt status register AACISR1 for CODEC channel one, the second CPU checks the read data to see if a transmit complete interrupt (TxCI) has occurred in step 1024. If the interrupt has occurred, the second automaton 1008 transitions to state qₒᵤₜ and increments the num_data variable. Until the next interrupt occurs, the second automaton 1008 remains in the q_{wait} state. Once num_data≧y, a “play” of the content is assumed to have occurred.

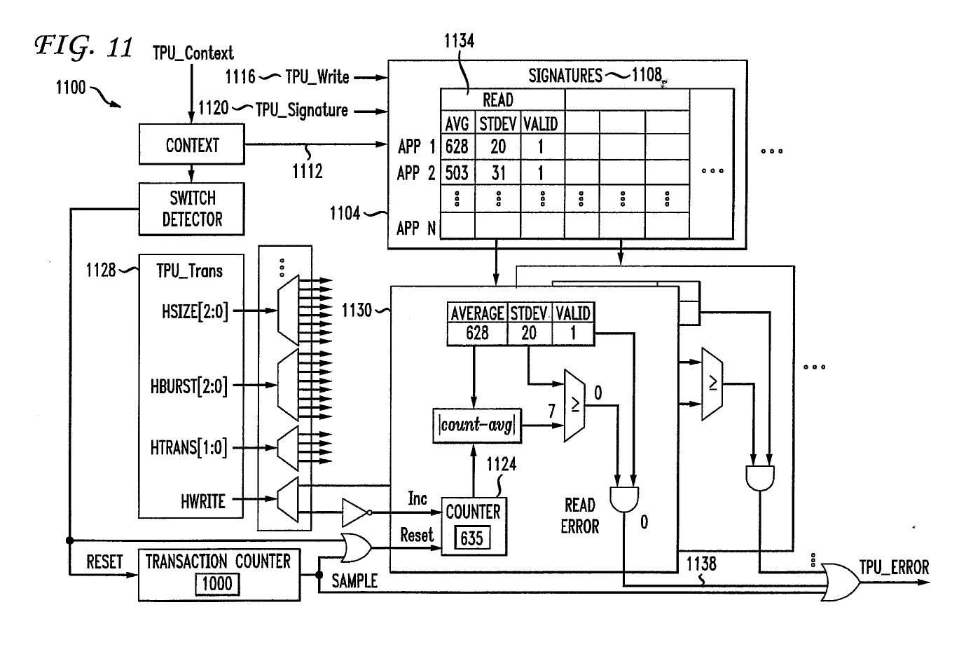

As described above, the TPU monitors the occurrence of bus transaction property values to determine if the behavior of the executing context approximates normal application behavior or whether there is an abnormality. FIG. 11 shows a block diagram of the TPU 1100. The TPU 1100 includes a memory 1104 for storing application signatures 1108 indexed by the TPU_Context input 1112 (coming from the Context register). In one embodiment, the memory 1104 is programmed by raising the TPU_Write line 1116 and applying the signature data on the TPU_Signature input 1120. One or more counters, such as counter 1124, can be used to maintain a record of the frequency of each transaction property value. TPU_Context 1112 can also function as a reset signal that clears the property value counters when a context switch occurs. When a new transaction completes, a TPU_Trans input 1128 delivers the data to the TPU 1100 and the transaction property values are extracted to increment the appropriate counters (e.g., counter 1124). Based on a pre-defined sampling period, the TPU 1100 can sample the counter array and compare the contents with the currently selected application signature. In one embodiment, if it is determined that the sample deviates a predetermined amount from the expected values, then a TPU_Error flag is raised and the SEM controller generates an interrupt.

Prior to execution on a target SoC platform, an application can be profiled with various input data sets to create one or more application signatures. In one embodiment, the application signature contains three attributes for each transaction property value: an average count, a standard deviation, and a valid bit indicating whether or not the property value is a useful measure of application behavior. Property values that have a large standard deviation often produce false positives and may be ignored.

In more detail, the TPU 1100 illustrates an embodiment of how a deviation in a property value frequency is detected. The application signatures 1108 are stored in a memory 1104 that is indexed by the current Context register value. Each property value column in the memory 1104 connects to a detection logic block, such as detection logic block 1130. The detection logic block (e.g., block 1130) contains a counter 1124 to accumulate property value occurrences during the current sampling period. When either a context switch occurs or the sampling period ends, the counter 1124 is reset for the next period. A transaction counter can be responsible for generating a sample signal to flag the end of a sampling period. An error generated by a detection logic block (e.g., block 1130) is valid when the sample signal is high and appears at the TPU_Error output.

The detection logic block 1130 can compare the number of reads completed by the current context with a stored average from the application signature. In one embodiment, read field 1134 of the signature memory 1104 shows that the TPU 1100 expects an average of 628 reads per sampling period with a standard deviation of 20. The standard deviation is used as a threshold between malicious and normal application behavior: in one embodiment, any count below the standard deviation is acceptable. In the example shown, the current count deviates by 7 reads from the average, so the last execution period exhibited an acceptable number of reads (below the standard deviation of 20). When the property value is valid, Read Error signal 1138 outputs the result of the comparison.

Using bus transaction property statistics is one method to characterize application behavior. Besides utilizing the standard deviation as a determiner of error, other statistical metrics may be employed. Application behavior can be represented by additional information, such as address and data values. Similar to intrusion detection systems, sequences of bus transaction information based on profiling can offer more accurate representations. In one embodiment, a hybridized method employing both application-specific knowledge and bus transaction information from an execution trace may be used.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A system comprising:
a communication bus comprising a data bus;
a plurality of components interconnected via said communication bus; and
a circuit configured to evaluate a security policy associated with said system by reading at least one data bus signal associated with a transaction between at least two of said plurality of components.

2. The system of claim 1 wherein said circuit is configured to enforce said security policy.

3. The system of claim 1 wherein said communication bus further comprises an address bus.

4. The system of claim 1 wherein said circuit reads at least one of at least one address bus signal and said at least one data bus signal off of said communication bus.

5. The system of claim 1 wherein said circuit uses information associated with a sequence of transactions to evaluate said security policy.

6. The system of claim 5 wherein said information associated with a sequence of transactions further comprises statistics associated with said sequence of transactions.

7. The system of claim 1 wherein said circuit further comprises a data-based protection unit (DPU) configured to restrict data values written to at least one component in said plurality of components.

8. The system of claim 1 wherein said circuit further comprises a sequence-based protection unit (SPU) configured to determine if said security policy is violated by checking a plurality of transactions executed.

9. The system of claim 1 wherein said circuit further comprises a statistical transaction protection unit (TPU) configured to determine if statistics associated with a sequence of transactions conflict with predetermined values of said system.

10. The system of claim 1 wherein said circuit is configured in a trusted manner for an application.

11. The system of claim 1 wherein said circuit further comprises an address-based protection unit (APU) configured to manage access control privileges of at least one component in said plurality of components in accordance with said security policy.

12. A method for evaluating a security policy associated with a system comprising a plurality of components interconnected via a communication bus having a data bus, the method comprising:
evaluating said security policy by reading at least one data bus signal associated with a transaction between at least two of said plurality of components.

13. The method of claim 12 further comprising enforcing said security policy.

14. The method of claim 12 further comprising reading said at least one data bus signal off of said communication bus.

15. The method of claim 12 further comprising using information associated with a sequence of transactions to evaluate said security policy.

16. The method of claim 15 wherein said using of said information further comprises using statistics associated with said sequence of transactions to evaluate said security policy.

17. The method of claim 12 further comprising restricting data values written to at least one component in said plurality of components.

18. The method of claim 12 further comprising determining if said security policy is violated by checking a plurality of transactions executed.

19. The method of claim 12 further comprising determining if statistics associated with a sequence of transactions conflict with predetermined values of said system.

20. The method of claim 12 further comprising managing access control privileges of at least one component in said plurality of components in accordance with said security policy.
